(19) United States
(12) Patent Application Publication
(10) Pub. No.: US 2004/0151269 A1
(43) Pub. Date: Aug. 5, 2004

(54) Receiver sampling in an ultra-wideband communications system

(76) Inventors: Jaiganesh Balakrishnan, Dallas, TX (US); Anuj Batra, Dallas, TX (US); Anand G. Dabak, Plano, TX (US); Ranjit Gharpurey, Ann Arbor, MI (US)

Correspondence Address: TEXAS INSTRUMENTS INCORPORATED, P O BOX 655474, M/S 3999, DALLAS, TX, 75265

(21) Appl. No.: 10/761,605

(22) Filed: Jan. 21, 2004

Related U.S. Application Data
(60) Provisional application No. 60/441,530, filed on Jan. 21, 2003.

(51) Int. Cl. H04L 7/00

(52) U.S. Cl. 375/355

(57) ABSTRACT

System and method for minimizing receiver sample timing error sensitivity. A preferred embodiment comprises matching received pulses to two pulses, a first pulse being advanced by a time offset and a second pulse being retarded by a time offset. Samples are created from the matching. The time offsets can be chosen based upon characteristics of the pulse itself. The samples can be combined to produce an output signal with less pronounced nulls that can reduce sensitivity to sample timing errors and a smoother overall profile that can enable gradient-based timing recovery scheme.

This application claims the benefit of U.S. Provisional Application No. 60/441,530, filed Jan. 21, 2003, entitled “Efficient Receiver Sampling of an Ultra-Wideband (UWB) Communication System,” which application is hereby incorporated herein by reference.

### CROSS-REFERENCE TO RELATED APPLICATIONS

This application is related to the following co-pending and commonly assigned patent application: Ser. No. ______, filed Jan. 16, 2003, Attorney Docket Number TI-35863, entitled “A Square-root Raised Cosine Ultra-wideband Communications System,” which is incorporated herein by reference.

### TECHNICAL FIELD

The present invention relates generally to a system and method for digital wireless communications, and more particularly to a system and method for minimizing receiver sample timing error sensitivity in an ultra-wideband communications system.

### BACKGROUND

Ultra-wideband (UWB) communications systems are normally defined as carrier-less or wavelet-based communications systems wherein the bandwidth of the signal being transmitted, f_{B}, is greater than or equal to 0.20f_{c}, where f_{c} is the center frequency of the signal being transmitted. Additionally, the UWB communications system should have a minimum bandwidth of 500 MHz. Note that the definition for UWB communications systems and devices is as defined by the Federal Communications Commission (FCC) of the United States. UWB communications systems have been around for a great number of years, and the majority of them fall under one type of system, they modulate a stream of short-duration pulses (with an approximate duration which ranges from 0.2 nanoseconds (ns) to 2 ns), either in time (pulse position modulation (PPM)), amplitude (pulse amplitude modulation (PAM)), or phase angle (bi-phase modulation).

However, the use of short-duration pulses transmitted in rapid succession can make it difficult for a UWB receiver to effectively detect the transmitted signal. For example, in a UWB communications system transmitting a Gaussian pulse, a sample timing offset of as small as 10 pico-seconds can result in a performance degradation of nearly 0.8 dB.

A commonly used prior art technique that permits adjusting the sample timing of a receiver involves the sampling of a received signal at on-time, early, and late instances. Wherein the on-time sample is taken at a time when the receiver expects the presence of pulse to be sampled, while the early and late samples are made at times that are slightly advanced and retarded with respect to the expected time. Then, the samples can be compared and the sampling of the received signal adjusted to the instance (either on-time, early, or late) that results in maximized received signal strength.

A prior art technique makes use of sampling the output of a matched filter that attempts to match the received signal with the impulse response of the communications channel. When there is a good match between the impulse response and the received signal, the output of the matched filter can be large. The samples can then be provided to a channel equalizer to undo the effects of multipath and a channel decoder for error correction.

One disadvantage of the prior art is that the use of the on-time, early, and late samples to adjust sample timing can be susceptible to locking onto local maximas rather than the actual maximum, therefore, the received signal may not be maximized.

A second disadvantage of the prior art is that the use of the matched filter needs the impulse response of the communications channel for optimal performance. Unfortunately, multipath in the communications channel can prevent the accurate estimation of the impulse response.

Another disadvantage of the prior art is that even with the use of the matched filter, for certain UWB pulses, accurate sample timing remains a crucial factor in maximizing received signal strength since small offsets in sample timing can significantly degrade receiver performance.

Yet another disadvantage of the prior art is that it can require an extremely accurate clock, which may be difficult (if not impossible) to generate. Therefore, without the presence of the accurate clock, receiver performance can suffer since good sampling of a received signal may not be possible.

### SUMMARY OF THE INVENTION

These and other problems are generally solved or circumvented, and technical advantages are generally achieved, by preferred embodiments of the present invention which provides for a system and method for maximizing receiver energy in a UWB communications system.

In accordance with a preferred embodiment of the present invention, a method for sampling a signal comprising matching the signal to a first receive pulse shape, matching the signal to a second receive pulse shape, sampling outputs from the first and second matching, and creating an output signal from the sampled outputs is provided.

In accordance with another preferred embodiment of the present invention, a method for reducing receiver sensitivity to sample timing errors comprising matching a received signal to a first received pulse shape, wherein the first received pulse shape is a representation of a pulse carried in the received signal, matching the received signal to a second received pulse shape, wherein the second received pulse shape is a representation of the pulse carried in the received signal, sampling outputs from the first and second matching, and combining the samples to create an output signal is provided.

In accordance with another preferred embodiment of the present invention, a circuit comprising a first matched filter coupled to a signal input, the first matched filter containing circuitry to compare a pulse provided by the signal input to a first receive pulse shape and to provide an output sample based upon the comparison, and a second matched filter coupled to the signal input, the second matched filter containing circuitry to compare a pulse provided by the signal input to a second receive pulse shape and to provide an output sample based upon the comparison is provided.

In accordance with another preferred embodiment of the present invention, a receiver comprising a band select filter coupled to a signal input, the band select filter containing circuitry to selectively pass a portion of a frequency band from a signal provided by the signal input, an amplifier coupled to the band select filter, the amplifier to bring an output of the band select filter to a desired level, a first matched filter coupled to the amplifier, the first matched filter containing circuitry to compare a pulse provided by the amplifier to a first receive pulse shape and to provide an output sample based upon the comparison, a second matched filter coupled to the amplifier, the first matched filter containing circuitry to compare a pulse provided by the amplifier to a second receive pulse shape and to provide an output sample based upon the comparison, and a decoder coupled to the first and the second matched filters, the decoder containing circuitry to detect and eliminate errors that may be present in the outputs produced by the first and the second matched filters is provided.

An advantage of a preferred embodiment of the present invention is that an accurate estimate of the impulse response of the communications channel is not required. This can simplify operation since in a multipath environment, accurate estimations of the impulse response can be difficult.

A further advantage of a preferred embodiment of the present invention is that accurate sample timing requirements are not as stringent as in the prior art matched filter technique.

Yet another advantage of a preferred embodiment of the present invention is that a timing recovery scheme making use of gradient-based timing recovery schemes, such as on-time, early, and late samples, can be easier to implement due to a smoother (fewer local maximas and minimas) matched filter output signal.

Yet another advantage of a preferred embodiment of the present invention is that it permits additional multipath channel energy to be collected, therefore, it can be possible to further increase receiver energy. With increased receiver energy, the overall system robustness can be increased.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a part of a carrier-less or wavelet-based ultra-wideband transmitter;

FIG. 2 is a diagram of a stream of ultra-wideband pulses;

FIG. 3 is a diagram of a portion of prior art ultra-wideband receiver;

FIG. 4 is a diagram of a receiver pulse shape;

FIG. 5 is a diagram of an auto-correlation function corresponding to the receiver pulse shape illustrated in FIG. 4;

FIGS. 6a and 6b are diagrams of a portion of receivers implementing a sampling technique to alleviate stringent timing requirements typically imposed upon ultra-wideband receivers, according to a preferred embodiment of the present invention;

FIG. 7 is a diagram of an exemplary implementation of a receiver, according to a preferred embodiment of the present invention;

FIG. 8 is a diagram of outputs from a pair of matched filters and a composite signal that can be a combination of the two outputs, according to a preferred embodiment of the present invention;

FIG. 9 is a flow diagram of an algorithm for improving receiver sensitivity to sample timing errors, according to a preferred embodiment of the present invention; and

FIG. 10 is a diagram of a portion of a receiver using early/late timing recovery using dual stream sampling, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a carrier-less or wavelet-based UWB communications system, such as those permitted by the Federal Communications Commission under Report Order 02-48 entitled “Revision of Part 15 of the Commission's Rules Regarding Ultra-Wideband Transmission Systems,” released Apr. 22, 2002, which is herein incorporated by reference. The invention may also be applied, however, to other communications systems where maximizing the received signal energy when the received signal is a pulse with known spectral specifications.

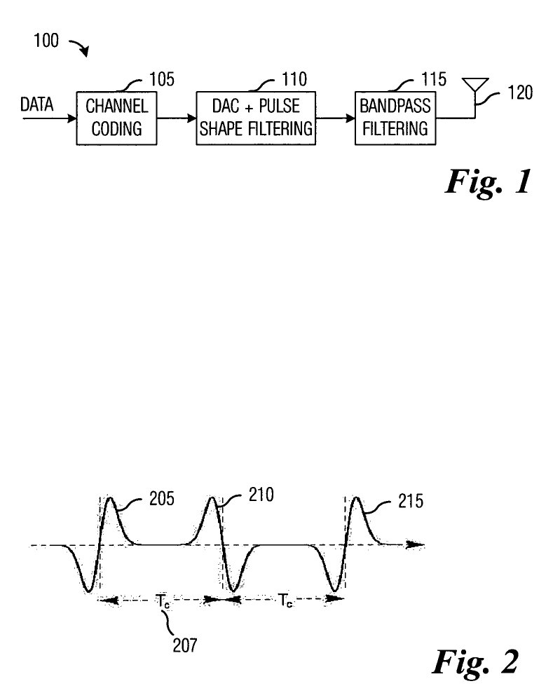

With reference now to FIG. 1, there is shown a diagram illustrating a portion of a carrier-less or wavelet-based UWB transmitter 100. A data stream, such as one provided by devices (not shown) coupled to the UWB transmitter 100, can be provided to a channel coding unit 105, which can be used to apply transmission codes (and perhaps error detecting and correcting codes). The encoded data stream can then be converted into an analog signal by a digital-to-analog converter (DAC) and then pulse shape filtered by a DAC and pulse shape filtering unit 110. After conversion into an analog signal and being pulse shape filtered, a signal to be transmitted can be filtered by a bandpass filtering unit 115 to help eliminate any signal outside of a desired frequency band and to meet technological and regulatory specifications. Finally, the signal to be transmitted can be provided to an antenna 120, where it can be transmitted over-the-air.

With reference now to FIG. 2, there is shown a diagram illustrating a sequence of UWB transmitted pulses. FIG. 2 displays a sequence of three UWB transmitted pulses 205, 210, and 215, wherein each pulse is a first derivative of a Gaussian pulse. Note that the first pulse 205 and the third pulse 215 have a similar appearance while the second pulse 210 is an inverse of the first and third pulses 205 and 215. The pulses 205, 210, and 215 are first derivatives of a Gaussian pulse which can be expressed mathematically as: pₜ(t)=Kte^{-(t/T}^{ₚ}⁾^{²}, wherein K is a normalization factor and Tp is a parameter of the Gaussian pulse. The modulation of the pulses may be one way that information is conveyed in the sequence. The pulses are equidistant from one another, for example, pulses 205 and 210 are separated by an interval 207. The duration of the interval may be a designer specified value, and is referred to as Tc in FIG. 2.

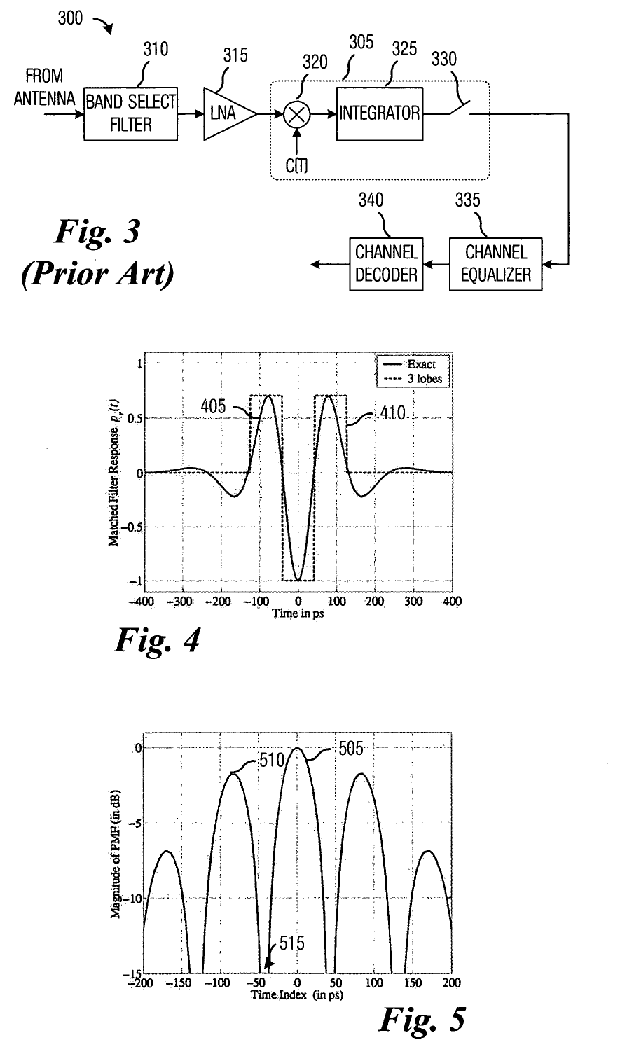

With reference now to FIG. 3, there is shown a diagram illustrating a portion of a receiver 300 wherein the receiver 300 makes use of a prior art technique of using a pulse-matched filter 305 to detect pulses in a received signal. The receiver 300 can use a band select filter 310 to eliminate signals that are outside of a particular band of interest that may be present in a received signal, wherein the received signal may be provided by an antenna (not shown). The band select filter 310 may also be set to select a single transmission channel out of several that may be used to transmit data in a communications system of which the receiver 300 is a part. The received signal can then be provide to an amplifier, preferably, a low noise amplifier (LNA) 315, which can be used to amplify the received signal to a level that is compatible with circuitry in the remainder of the receiver 300.

After amplification, the received signal may be provided to the pulse-matched filter 305, which can comprise of a multiplier 320, an integrator 325, and a switch 330. The multiplier 320 can be used to multiply the received signal with a pulse, c(t), to which it is being matched. The pulse, c(t), may be the impulse response of the communications channel that is being used to carry the transmitted signal. The combination of the multiplier 320 and the integrator 325 can be used as the implementation of the pulse-matched filter 305 while the switch 330 can be used to provide samples of the output of the matched filter (the combination of the multiplier 320 and the integrator 325) at a sampling rate that can be essentially equal to the symbol rate, Rc, of the received signal. Note that the integrator 325 can be reset after every sample. The output of the matched filter 305 can be equalized by a channel equalizer 335 to undo the effects of any multipath and then passed to a channel decoder 340 for error detection.

The use of the receiver 300 may require three assumptions: 1) a continuous-time-domain impulse response (the pulse, c(t)) is known at the receiver 300; 2) if the pulse, c(t), is known, then it is possible to implement a filter matched to the pulse, c(t); and 3) accurate timing information is available to the sampling circuitry (the switch 330). However, in reality, although a multipath channel impulse response may be estimated at the receiver 300, it can be extremely difficult to implement a filter matched to the estimated continuous-time-impulse response, c(t). Therefore, it may be typical for the filter to be matched to an impulse response, pᵣ(t), wherein pᵣ(t) may be a convolution of a transmit pulse shape, pₜ(t), a band-pass filter impulse response, and an antenna impulse response. If the operating environment of the receiver 300 has only a line-of-sight path and no multipath reflections, then pᵣ(t) can be equal to c(t). Note that pᵣ(t) can be referred to as a receiver pulse shape.

With reference now to FIG. 4, there is shown a diagram illustrating a receiver pulse shape, pᵣ(t), for the transmit pulse shape 205 (FIG. 2). FIG. 4 illustrates two curves, a first curve 405 represents an exact representation of the receiver pulse shape, pᵣ(t), while a second curve 410 represents a three-lobe square-wave approximation of the receiver pulse shape, pᵣ(t). The second curve 410 may permit an easier implementation of a pulse-matched filter, such as the pulse-matched filter 305 (FIG. 3). Note that the second curve 410 follows the first curve 405 quite closely.

With reference now to FIG. 5, there is shown a diagram illustrating an auto-correlation function corresponding to a receiver pulse shape, pᵣ(t), for the transmit pulse shape 205 (FIG. 2). A curve 505, made up of five peaks, shows correlation results of the receive pulse shape, pᵣ(t), to itself with differing time offsets (displayed as the horizontal axis). The auto-correlation results show that when the receiver pulse shape, pᵣ(t), is correlated with itself with zero time offset, the correlation is at its greatest. The autocorrelation results also show that there are several local maximas (such as local maxima 510) for when the receiver pulse shape, pᵣ(t), is correlated with itself with a time offset approximately equal to ±2Δ, ±4Δ, wherein Δ=42.5 picoseconds. Furthermore, there are several nulls (such as null 515) when the receiver pulse shape, pᵣ(t), is correlated with itself with a time offset approximately equal to ±1Δ, ±3Δ. Note that the value of Δ=42.5 picoseconds can be specific to the transmit pulse shape 205 (FIG. 2) with specific timing characteristics and that it can differ for different transmit pulses with different shapes and timing characteristics.

With an auto-correlation function with many local maximas and nulls, relatively small timing errors in a matched-pulse filter can result in significantly reduced received signal strengths. Furthermore, the many local maximas and nulls can make it difficult to implement a stochastic gradient-descent based timing recovery scheme such as the early-late technique because they can lock onto one of the many local maximas.

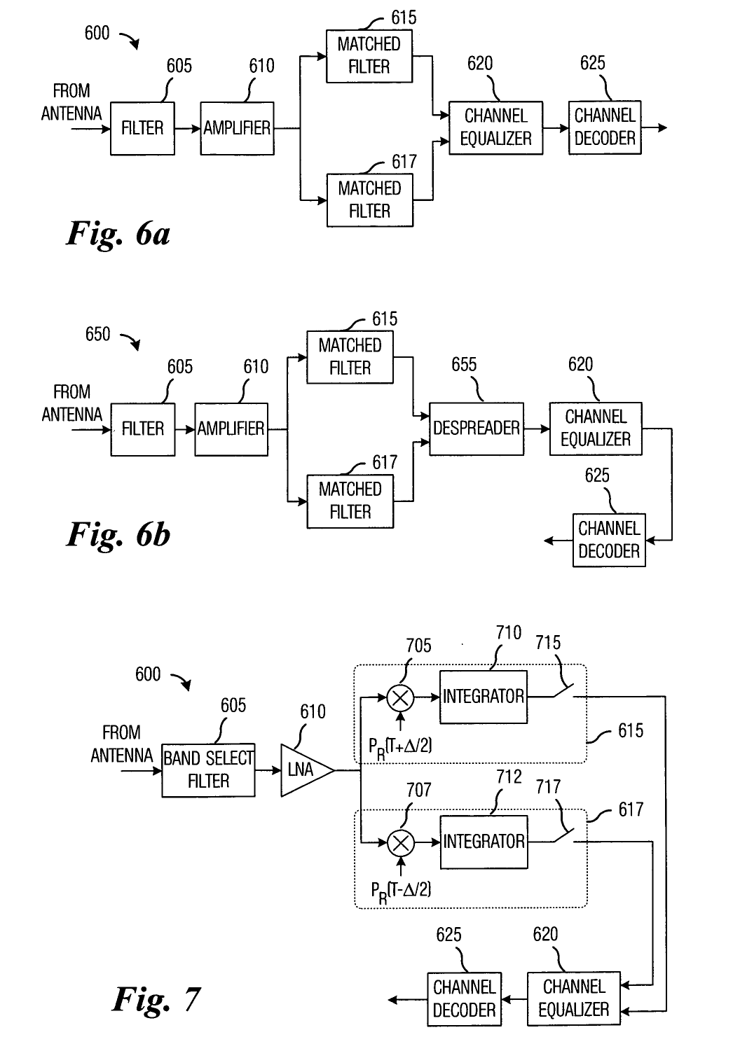

With reference now to FIG. 6a, there is shown a diagram illustrating a portion of a receiver 600 wherein the receiver 600 features a sampling technique to alleviate the stringent timing requirements typically imposed upon UWB receivers, according to a preferred embodiment of the present invention. The receiver 600 features a filter 605 to help eliminate out-of-band interferers that may be present in a received signal, which may be provided by an antenna (not shown). After filtering, the received signal may be amplified to a signal level compatible with other circuitry in the receiver 600 by an amplifier 610.

The amplified and filtered received signal can then be provided to a pair of matched filters 615 and 617. The pair of matched filters 615 and 617 may be similar to the pulse-matched filter 305 (FIG. 3) in that they match an input signal (the amplified and filtered received signal) to another input signal (in this case, a receiver pulse shape). According to a preferred embodiment of the present invention, one of the matched filters (for example, the matched filter 615) can match the amplified and filtered received signal to the receiver pulse shape that has been advanced a first specified amount, while the other matched filter (for example, the matched filter 617) can match the amplified and filtered received signal to the receiver pulse shape that has been retarded a second specified amount. Note that there can be other ways to produce the matched filter outputs. One way would be to implement a digital matched filter. This can be done by sampling the output of the amplifier 610 with a very high data rate ADC (preferably at least twice the largest frequency used by the UWB communications system) and implementing a digital pulse/channel matched filter of the sampled signal.

The pair of matched filters 615 and 617 can then produce a pair of sample streams, which can be referred to as sample stream one (S1) and sample stream two (S2). Note that it can be possible to produce streams in addition to the sample streams one and two. However, there may be no clear advantage in doing so. The sample streams one and two, which can now be expressed as: y(n)=y_{S1}(n)+j*y_{S2}(n), can then be provided to a channel equalizer 620 to compensate for any channel multipath. Note that the channel equalizer 620 may also be optional. For example, when there is sufficient spreading gain, a channel equalizer 620 may not be needed. According to a preferred embodiment of the present invention, the time offsets (the first and the second specified amounts), when chosen properly can help alleviate strict timing requirements for the receiver 600. The choosing of the time offsets can be dependent upon the timing characteristics of the pulse being received. A detailed discussion of the matched filters 615 and 617 and the selection of the time offsets is provided below. Finally, a channel decoder 625 can be used for error correction purposes.

The channel equalizer 620 may optionally include an additional function (not shown) in the form of a decision feedback equalizer (DFE), a reduced-state sequence estimator (RSSE), a maximum-likelihood sequence estimator (MLSE) or other equalizer structures. This optional equalizer function may be useful when inter-symbol interference (ISI) impacts performance at higher data rates (when the received signal's spreading gain can become small) and when multipath becomes significant. The optional equalizer function can be adaptive (wherein coefficients of the channel equalizer 620 can be updated periodically during a payload portion of a packet) or non-adaptive (wherein coefficients of the channel equalizer 620 are frozen after the training period).

With reference now to FIG. 6b, there is shown a diagram illustrating a portion of a receiver 650 wherein the receiver features a sampling technique to alleviate the stringent timing requirements typically imposed upon UWB receivers, according to a preferred embodiment of the present invention. Note that the receiver 650 is similar to the receiver 600 (FIG. 6a) with the exception of a despreader 655 located between the matched filters 615 and 617 and the channel equalizer 620. The presence of the despreader 655 may be necessary if the communications system were to use a spread-spectrum based modulation scheme, such as code-division multiple access (CDMA). Note that the inclusion of the despreader may not change the structure of the matched filter or the mathematical representation of the composite output in any way.

With reference now to FIG. 7, there is shown a diagram illustrating an exemplary implementation of the receiver 600, according to a preferred embodiment of the present invention. Similar to the pulse-matched filter 305 (FIG. 3), each filter in the pair of matched filters 615 and 617 can be implemented as a multiplier (such as multiplier 705 and 707), an integrator (such as integrator 710 and 712), and a switch (such as switch 715 and 717). The multiplier 705 has a first input (the amplified and filtered received signal) and a second input (a pulse that is to be matched with the amplified and filtered received signal). For example, the multiplier 705 may have as its second input, a receiver pulse shape, pᵣ(t+Δ/2), while the multiplier 707 (from the matched filter 617) may have as its second input, a receiver pulse shape, pᵣ(t−Δ/2). The value Δ/2 may be the time offset. Note that in this particular example, the time offset is the same for each matched filter, with the matched filter 615 being advanced Δ/2 and the matched filter 617 being retarded Δ/2. Using the transmit pulse illustrated in FIG. 2, an ideal value for Δ can be 42.5 picoseconds. As before, it is the combination of a multiplier and an integrator (such as the multiplier 705 and the integrator 710) that makes up a pulse-matched filter.

Output from the integrators 710 and 712 may then be sampled by the switches 715 and 717. According to a preferred embodiment of the present invention, the switches 715 and 717 sample the integrator outputs at the same sampling rate of Rc. An amount of time between samples can be k*Tc+τ, wherein τ is a sample timing offset and k is the oversampling rate (if k is less than one (1), then the integrator outputs are being oversampled). Note that both switches 715 and 717 should be producing samples at essentially the same rate and at the same time to help prevent mismatch between the two sample streams.

As discussed previously, the outputs of the matched filters 615 and 617 may be provided to a despreader (not shown in FIG. 7, but shown in FIG. 6b), which can be used to demodulate the received signal if the communications system were a spread-spectrum communications system, such as a CDMA system. The output of the despreader may be provided to the channel equalizer 620, which may be optional.

Depending upon the value of the sample timing offset, τ, the components of the sample streams one and two can capture a weighted combination of the desired signal, namely the sample corresponding to the peak of the autocorrelation function, to maximize the strength of the received signal. Note that increasing the strength of the received signal can also increase the robustness of the communications as a whole. It can be shown that, depending upon the choice for the time offsets (the first and second specific amounts (which preferably are equal)), noise components of y_{S1}(n) and y_{S2}(n) can be uncorrelated to each other. Hence, y_{S1}(n) and y_{S2}(n) can be processed using a technique analogous to maximal-ratio combining. For example, in a single path channel, if a sample timing offset is equal to zero, then the samples of the sample streams one and two can have the same expected value, i.e., E(y_{S1}(n))=E(y_{S2}(n)). Therefore, the output of the channel equalizer 620 can be expressed as {y_{S1}(n)+y_{S2}(n)}/\sqrt{2}.

In general, a real output sequence obtained from combining the two streams (sample streams one and two) for an AWGN (additive white Gaussian noise) (or a single path) channel can be given by:

ν(n)=Re{(α−jβ)y(n)}=αy_{S1}(n)+βy_{S2}(n),

wherein α and β are weighting factors that can be a function of the sample timing offset, τ. Note that the weighting factors, α and β, can be obtained by estimating an equivalent channel impulse response. This estimation can be done either during a training phase (during which a known preamble sequence is transmitted) or during a data transmission phase (using a blind channel estimation technique) or a mixture of the two (using a semi-blind channel estimation technique).

Furthermore, the weighting factors, α and β, can either be fixed or modified during the course of a packet using adaptive techniques. The weighting factors can be varied over the duration of a packet to compensate for changes in the channel impulse response that could be the result of variations in the physical channel, timing drift caused by crystal oscillator mismatch between transmitter and receiver, and so forth.

When there is multipath present, the sample streams one and two can be combined in a tapped-delay line fashion using a complex FIR equalizer that could be estimated during a training phase of the receiver 600. The real output sequence of the channel equalizer 620 for a multipath channel can be given by:

$$v ( n ) = Re [ {\sum }_{k = 0}^{L - 1} \{ α ( k ) - j β ( k ) \} y ( n - k ) ] = {\sum }_{k = 0}^{L - 1} \{ α ( k ) {y}_{S1} ( n - k ) + β ( k ) {y}_{S2} ( n - k ) \} .$$

As discussed above, the channel equalizer 620 may include an optional function that can implement additional multipath processing of the received signal (in lieu of or in addition to the simple combining or tapped-delay line processing shown above) in the form of a decision feedback equalizer (DFE), a reduced-state sequence estimator (RSSE), a maximum-likelihood sequence estimator (MLSE) or other equalizer structures.

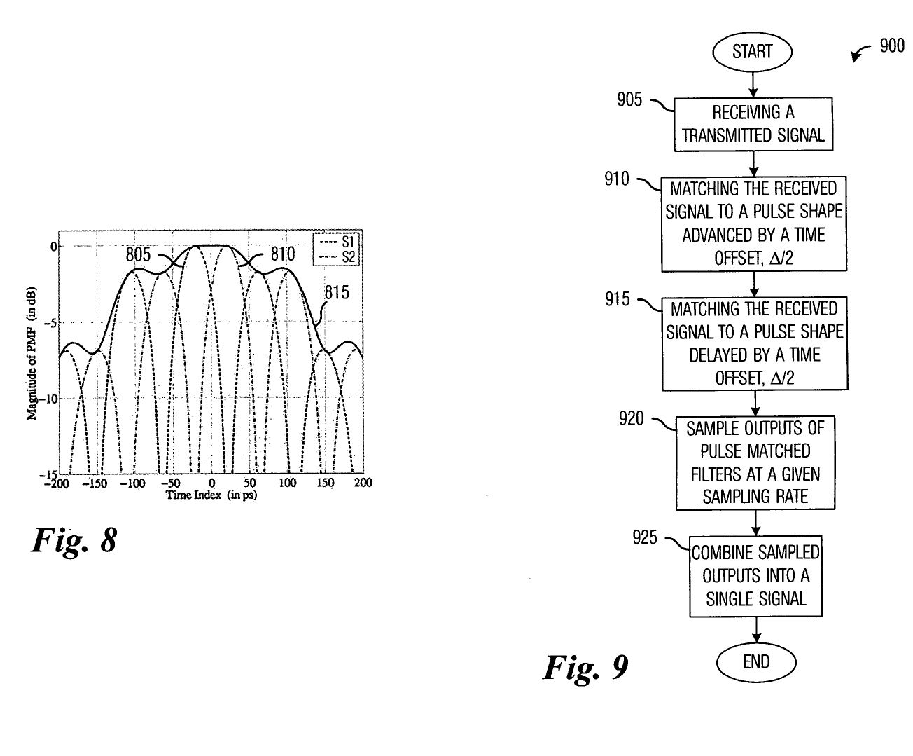

With reference now to FIG. 8, there is shown a diagram illustrating outputs from a pair of matched filters and a composite signal that can be a combination of the two outputs, according to a preferred embodiment of the present invention. A first curve 805 displays an output from a first matched filter (for example, matched filter 615 (FIG. 6)) and a second curve 810 displays an output from a second matched filter (for example, matched filter 617 (FIG. 6)) for a single path channel as a function of the sample timing offset, τ. A third curve 815 can be a combination of the first and the second curves 805 and 810. The third curve 815 can be referred to as a composite pulse-matched filter output (a combination of the two matched filters 615 and 617, for example). Note that the combination of the first and second curves 805 and 810 displayed in FIG. 8 may be a simple equal gain combining of the two curves. Different results may be achieved by applying different weights (gains) to the first and the second curves 805 and 810, should a need arise.

The third curve 815 shows that the present invention can be relatively less sensitive to sample timing offset errors (there are no significant nulls along the third curve 815 that could show a sharp reduction in received signal strength should there be a timing offset error). Comparing this to the output of the auto-correlation function of the receiver pulse waveform displayed in FIG. 5, the nulls in the third curve 815 may be negligible. Furthermore, the composite pulse-matched filter output does not have significant local maximas, the presence of which could make it difficult to implement a gradient-based timing recovery scheme such as the early-late technique.

The use of the composite pulse-matched filter output (the third curve 815) can also permit more multipath channel energy to be collected, which can result in a stronger received signal. If a single sample per chip is used (i.e., the conventional sampling technique), a rake receiver, which can be used to collect and combine multipath energy, may not be able to collect multipath energy from paths that arrive at delays that correspond to nulls in the auto-correlation function (see FIG. 5). However, with the use of the composite pulse-matched filter output (as shown in FIG. 8), the rake receiver will be able to collect multipath energy at these delays since there may not be any nulls at these delays and if there are, the nulls may not be significant nulls. For example, in a channel model specified in an IEEE 802.15 technical specifications document for UWB communications systems, the use of the composite pulse-matched filter can collect nearly 2.5 dB of additional multipath energy when compared to the conventional sampling technique.

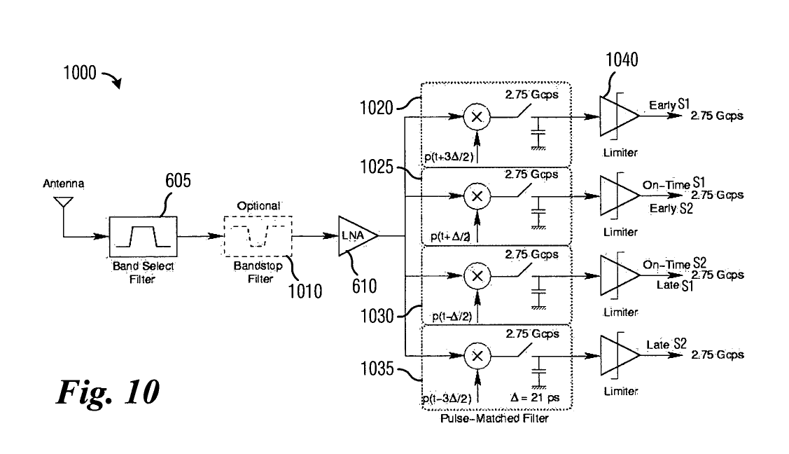

With reference now to FIG. 9, there is shown a flow diagram illustrating an algorithm 900 for improving receiver sensitivity to sample timing errors, according to a preferred embodiment of the present invention. According to a preferred embodiment of the present invention, the algorithm 900 can execute on a controller, a processing unit, a processing element, or a custom design integrated circuit that can be responsible for the operations of a receiver (not shown). The algorithm 900 can be in continuous execution after the receiver has been powered on and ready to begin receiving transmissions.

With the receiver operating normally, it can receive transmissions from a transmitter operating in the general vicinity via an antenna or some type of sensor such as a photo-sensitive detector (block 905). The transmission may be data or it may contain control information that is to be used by the receiver. A received signal, provided to receiver circuitry, by the antenna (or sensor) can be provided to a first pulse-matched filter, wherein the received signal can be pulsed matched to a receive pulse that has been advanced by a first time offset (block 910). The same signal can also be provided to a second pulse-matched filter, wherein the received signal can be pulsed matched to a received pulse that has been advanced by a second time offset (block 915).

According to a preferred embodiment of the present invention, the first and the second time offset can be essentially equal in magnitude, preferably equal to Δ/2, wherein Δ is a function of the pulse being received at the receiver. For example, if the pulse being received is a Gaussian pulse with a first derivative expressible as discussed in FIG. 2 with a Tp of 43.2 picoseconds, then Δ can be equal to 42.5 picoseconds. Note that the value of Δ can be different for other pulse shapes and can be determined by the characteristics of the pulse itself. Furthermore, the value of Δ can also be determined adaptively, perhaps during a training period or as the received signal is being received. As the received signal is being pulsed matched (blocks 910 and 915), the outputs of the pulse-matched filters may be sampled at a specified sampling rate (block 920). A discussion of the specified sampling rate is presented above. Note that it may be desirable that the sampling for the outputs of the pulse-matched filters be made at the same instant of time. The samples of the outputs of the pulse-matched filter may then be combined (block 925). As discussed above, the combination of the two sample streams of the outputs of the pulse-matched filters can be a simple weighted combining of the samples when there is no multipath present. When multipath is present, then the two sample streams can be combined in a tapped-delay line fashion using a complex FIR equalizer.

With reference now to FIG. 10, there is shown a diagram illustrating a portion of a receiver 1000 implementing early/late timing recovery with dual stream sampling, according to a preferred embodiment of the present invention. The receiver 1000 can feature the band select filter 605 to help eliminate out-of-band interferes from a received signal, which may be provided by an antenna, and the amplifier 610 to amplify the received signal to a level compatible with other circuitry in the receiver 1000. An optional bandstop filter can also be present to help eliminate known interferers, such as transmissions from electronics devices operating within specific frequency bands, such as the UNII band.

The receiver 1000 can implement early/late timing recovery with a bank of pulse matched filters, such as pulse matched filters 1020, 1025, 1030, and 1035, wherein the pulse matched filters can be similar in design and receiver pulse shape but with different timing for the receiver pulse shape. For example, the pulse matched filter 1020 can be used to provide early samples for the sample stream one sequence. This may be done by matching the received signal with the receiver pulse shape that has been advanced by 3Δ/2. Similarly, the pulse matched filter 1025 can be used to provide on-time samples of the sample stream one sequence. In this case, the receiver pulse shape can be advanced by Δ/2. Note that a reduction in the number of pulse matched filters can be achieved by sharing certain pulse matched filters, for example, the samples produced by the pulse matched filter 1025, which can be used as the on-time samples of the sample stream one (S1) sequence can also be used as the early samples of the sample stream two (S2) sequence. Similarly, the samples produced by the pulse matched filter 1030 can be used as both the late samples of the S1 sequence and the on-time samples of the S2 sequence.

Each of the pulse matched filters, for example, the pulse matched filter 1020, can have a limiter, for example, limiter 1040 at its output that can be used to establish a maximum value upon the sample streams being produced by the pulse matched filters. The sample streams (early/on-time/late for the S1 and S2 streams) can then be compared and the timing of the pulse matched filters can be adjusted in such a way that the samples with the largest magnitudes may be produced by the on-time sample providers. Note that should the receiver 1000 include an optional despreader, the early/late timing recover can also be performed after the received signal has been despread.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for sampling a signal comprising:
matching the signal to a first receive pulse shape;
matching the signal to a second receive pulse shape;
sampling outputs from the first and second matching; and
creating an output signal from the sampled outputs.

2. The method of claim 1, wherein the first and the second receive pulse shapes are essentially equal, and wherein the first receive pulse shape has been advanced a first time offset and the second received pulse shape has been retarded a second time offset.

3. The method of claim 2, wherein the first time offset and the second time offset are essentially equal.

4. The method of claim 2, wherein the first and the second time offsets can be determined from characteristics of the signal.

5. The method of claim 2, wherein the first and the second time offsets can be determined adaptively.

6. The method of claim 1, wherein the sampling occurs at the same time for each output.

7. The method of claim 6, wherein the sampling occurs at a sampling rate that can be determined from expected characteristics of the signal.

8. The method of claim 1, wherein the creating comprises adding the sampled outputs together.

9. The method of claim 8, wherein samples from each output are multiplied by a weighting factor prior to the adding.

10. The method of claim 9, wherein the weighting factor is the same for all samples from an output.

11. The method of claim 9, wherein the weighting factor can be different for each output.

12. The method of claim 1, wherein the creating comprises combining the outputs in a tapped-delay line fashion.

13. The method of claim 12, wherein the output signal can be expressed as:
$$Re [ {\sum }_{k = 0}^{L - 1} \{ α ( k ) - j β ( k ) \} y ( n - k ) ] = {\sum }_{k = 0}^{L - 1} \{ α ( k ) {y}_{i} ( n - k ) + β ( k ) {y}_{q} ( n - k ) \} ,$$
wherein the output signal is real-valued, α and β are weighting factors, yᵢ(n) and y_{q}(n) are the outputs, and y(n) is equal to yᵢ(n)+y_{q}(n), and L is the length of the tapped-delay line.

14. A method for reducing receiver sensitivity to sample timing errors comprising:
matching a received signal to a first received pulse shape, wherein the first received pulse shape is a representation of a pulse carried in the received signal;
matching the received signal to a second received pulse shape, wherein the second received pulse shape is a representation of the pulse carried in the received signal;
sampling outputs from the first and second matching; and
combining the samples to create an output signal.

15. The method of claim 14, wherein the first received pulse shape is advanced by a first time offset and the second received pulse shape is retarded by a second time offset.

16. The method of claim 15, wherein the first and the second time offsets are essentially equal.

17. The method of claim 15, wherein the first and the second time offsets can be chosen based upon an auto-correlation function of the pulse.

18. The method of claim 15, wherein the first and the second time offsets can be chosen adaptively.

19. The method of claim 14, wherein in an additive white Gaussian noise situation, the outputs can be combined by addition.

20. The method of claim 19, wherein the samples from one output are multiplied by a first weighting factor and the samples from the other output are multiplied by a second weighting factor prior to the addition.

21. The method of claim 14, wherein in a multipath situation, the outputs can be combined in a tapped-delay line fashion.

22. The method of claim 21, wherein the combining can be expressed as:
$$Re [ {\sum }_{k = 0}^{L - 1} \{ α ( k ) - j β ( k ) \} y ( n - k ) ] = {\sum }_{k = 0}^{L - 1} \{ α ( k ) {y}_{i} ( n - k ) + β ( k ) {y}_{q} ( n - k ) \}$$
wherein the output signal is real-valued, α and β are weighting factors, yᵢ(n) and y_{q}(n) are the outputs, and y(n) is equal to yᵢ(n)+y_{q}(n), and L is the length of the tapped-delay line.

23. The method of claim 21, wherein the combining further comprises equalizing the samples.

24. The method of claim 23, wherein the equalizing implements an equalizer of a type selected from a group consisting of a decision feedback equalizer (DFE), a reduced-state sequence estimator (RSSE), a maximum-likelihood sequence estimator (MLSE) or combinations thereof.

25. The method of claim 14 further comprising after the combining, adjusting sample timing.

26. The method of claim 25, wherein the adjusting comprises:
comparing an early, on-time, and late sampling of a sample; and
setting the sample timing to the sampling of a largest value.

27. The method of claim 25 further comprising despreading the samples prior to the adjusting.

28. The method of claim 25 further comprising despreading the samples after the adjusting.

29. A circuit comprising:
a first matched filter coupled to a signal input, the first matched filter containing circuitry to compare a pulse provided by the signal input to a first receive pulse shape and to provide an output sample based upon the comparison; and
a second matched filter coupled to the signal input, the second matched filter containing circuitry to compare a pulse provided by the signal input to a second receive pulse shape and to provide an output sample based upon the comparison.

30. The circuit of claim 29 further comprising an equalizer coupled to the first and the second matched filters, the equalizer containing circuitry to combine samples produced by the first and the second matched filters to produce an output signal.

31. The circuit of claim 29, wherein each matched filter comprises:
a multiplier to multiply the pulse with a receive pulse shape;
an integrator coupled to the multiplier, the integrator to accumulate a value from an output produced by the multiplier; and
a sampler coupled to the integrator, the sampler to periodically create a sample based upon the accumulated value from the integrator.

32. The circuit of claim 31, wherein the sampler is a switch that periodically closes to produce a sample.

33. The circuit of claim 32, wherein the period is based upon a frequency of the pulses provided by the signal input.

34. The circuit of claim 33, wherein the period is further based upon a data rate of information carried in the pulses provided by the signal input.

35. The circuit of claim 29, wherein the first receive pulse shape is an advanced version of the pulse and the second receive pulse shape is a retarded version of the pulse.

36. A receiver comprising:
a band select filter coupled to a signal input, the band select filter containing circuitry to selectively pass a portion of a frequency band from a signal provided by the signal input;
an amplifier coupled to the band select filter, the amplifier to bring an output of the band select filter to a desired level;
a first matched filter coupled to the amplifier, the first matched filter containing circuitry to compare a pulse provided by the amplifier to a first receive pulse shape and to provide an output sample based upon the comparison;
a second matched filter coupled to the amplifier, the first matched filter containing circuitry to compare a pulse provided by the amplifier to a second receive pulse shape and to provide an output sample based upon the comparison; and
a decoder coupled to the first and the second matched filters, the decoder containing circuitry to detect and eliminate errors that may be present in the outputs produced by the first and the second matched filters.

37. The receiver of claim 36, wherein the receiver operates in a wireless communications network.

38. The receiver of claim 37, wherein the wireless communications network is an ultra-wideband communications network.

39. The receiver of claim 38, wherein the wireless communications network is a carrier-less ultra-wideband communications network.

40. The receiver of claim 38, wherein the wireless communications network is a wavelet-based ultra-wideband communications network.

41. The receiver of claim 36 further comprising an equalizer coupled to the first and the second matched filters, the equalizer containing circuitry to combine samples produced by the first and the second matched filters to produce an output signal.

42. The receiver of claim 36 further comprising a despreader having inputs coupled to the first and second matched filter and an output coupled to the equalizer, the despreader containing circuitry to remove a spreading code that is present in the signal.

43. The receiver of claim 36 further comprising:
a despreader having inputs coupled to the first and second matched filter and an output coupled to the equalizer, the despreader containing circuitry to remove a spreading code that is present in the signal; and
an equalizer coupled to the despreader, the equalizer containing circuitry to combine an output produced by the despreaders to produce an output signal.
